(19) United States
(12) Patent Application Publication
(10) Pub. No.: US 2024/0297359 A1
(43) Pub. Date: Sep. 5, 2024

(54) THERMAL EXCHANGE PLATE HAVING MULTIPLE FLOW PATHS OF SUBSTANTIALLY EQUAL LENGTH

(71) Applicant: Ford Global Technologies, LLC, Dearborn, MI (US)

(72) Inventor: Xiaogang Zhang, Novi, MI (US)

(21) Appl. No.: 18/115,859

(22) Filed: Mar. 1, 2023

(51) Int. Cl. H01M 10/625; H01M 10/6554; H01M 10/6556

(52) U.S. Cl. CPC H01M 10/625; H01M 10/6554; H01M 10/6556; H01M 2220/20

(57) ABSTRACT

This disclosure relates to a battery assembly for an electrified vehicle. The battery assembly includes a thermal exchange plate, which includes a multiple flow paths of substantially equal length. Among other benefits, the disclosed thermal exchange plate achieves relatively low pressure loss, even fluid distribution, and relatively high heat transfer.

### TECHNICAL FIELD

This disclosure relates to a battery assembly for an electrified vehicle. The battery assembly includes a thermal exchange plate, which includes multiple flow paths of substantially equal length.

### BACKGROUND

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by battery powered electric machines. Conventional motor vehicles, by contrast, rely exclusively on the internal combustion engine to propel the vehicle.

High voltage battery assemblies are employed to power the electric machines of electrified vehicles. The battery assemblies include battery arrays constructed of a plurality of battery cells. An enclosure assembly houses the battery arrays. A thermal exchange plate may be placed adjacent the battery cells to thermally manage the battery cells.

### SUMMARY

In some aspects, the techniques described herein relate to a battery assembly, including: a plurality of battery cells; and a thermal exchange plate configured to thermally condition the plurality of battery cells, wherein the thermal exchange plate includes a first flow path and a second flow path, wherein the first flow path has a length substantially equal to a length of the second flow path.

In some aspects, the techniques described herein relate to a battery assembly, wherein: the thermal exchange plate includes an inlet and an outlet, the thermal exchange plate is configured such that fluid entering the inlet is split and flows through either the first flow path and the second flow path, and both the first flow path and the second flow path direct fluid to the outlet.

In some aspects, the techniques described herein relate to a battery assembly, wherein the first flow path and the second flow path merge at a location upstream of the outlet.

In some aspects, the techniques described herein relate to a battery assembly, wherein: downstream of the inlet, the first flow path includes a first section free of thermal exchange features, and downstream of the first section of the first flow path, the first flow path includes a second section including thermal exchange features.

In some aspects, the techniques described herein relate to a battery assembly, wherein: downstream of the inlet, the second flow path includes a first section including thermal exchange features, and downstream of the first section of the second flow path, the second flow path includes a second section free of thermal exchange features.

In some aspects, the techniques described herein relate to a battery assembly, wherein a length of the first section of the first flow path is substantially equal to a length of the second section of the second flow path.

In some aspects, the techniques described herein relate to a battery assembly, wherein a length of the second section of the first flow path is substantially equal to a length of the first section of the second flow path.

In some aspects, the techniques described herein relate to a battery assembly, wherein the thermal exchange features of the second section of the first flow path and the first section of the second flow path include baffles.

In some aspects, the techniques described herein relate to a battery assembly, wherein the baffles are arranged to establish a serpentine flow path within the second section of the first flow path and the first section of the second flow path.

In some aspects, the techniques described herein relate to a battery assembly, wherein the thermal exchange features of the second section of the first flow path and the first section of the second flow path include turbulators.

In some aspects, the techniques described herein relate to a battery assembly, wherein the thermal exchange features of the second section of the first flow path and the first section of the second flow path include fins.

In some aspects, the techniques described herein relate to a battery assembly, wherein the thermal exchange plate is in contact with the plurality of battery cells either directly or by way of a thermal interface material.

In some aspects, the techniques described herein relate to a battery assembly, further including a source of fluid in communication with the thermal exchange plate.

In some aspects, the techniques described herein relate to a battery assembly, wherein the battery assembly is a battery assembly of an electrified vehicle.

In some aspects, the techniques described herein relate to a method of an assembly, including: establishing a flow of fluid within a thermal exchange plate of a battery assembly such that the fluid flows along either a first flow path or a second flow path, wherein the first flow path has a length substantially equal to a length of the second flow path.

In some aspects, the techniques described herein relate to a method, wherein: the thermal exchange plate includes an inlet and an outlet, downstream of the inlet, fluid splits and flows through either the first flow path and the second flow path, and both the first flow path and the second flow path direct fluid to the outlet.

In some aspects, the techniques described herein relate to a method, wherein the first flow path and the second flow path merge at a location upstream of the outlet.

In some aspects, the techniques described herein relate to a method, wherein: downstream of the inlet, the first flow path includes a first section free of thermal exchange features, downstream of the first section of the first flow path, the first flow path includes a second section including thermal exchange features, downstream of the inlet, the second flow path includes a first section including thermal exchange features, and downstream of the first section of the second flow path, the second flow path includes a second section free of thermal exchange features.

In some aspects, the techniques described herein relate to a method, wherein a length of the first section of the first flow path is substantially equal to a length of the second section of the second flow path.

In some aspects, the techniques described herein relate to a method, wherein a length of the second section of the first flow path is substantially equal to a length of the first section of the second flow path.

### BRIEF DESCRIPTION OF THE DRAWINGS

FIG. 1 illustrates a side view of an electrified vehicle.

FIG. 2 illustrates an example battery pack assembly, with a portion of an enclosure assembly partially removed such that some internal battery pack components are visible.

FIG. 3 illustrates a first example thermal exchange plate.

FIG. 4 illustrates a second example thermal exchange plate.

### DETAILED DESCRIPTION

This disclosure relates to a battery assembly for an electrified vehicle. The battery assembly includes a thermal exchange plate, which includes a multiple flow paths of substantially equal length. Among other benefits, which will be appreciated from the below description, the disclosed thermal exchange plate achieves relatively low pressure loss, even fluid distribution, and relatively high heat transfer.

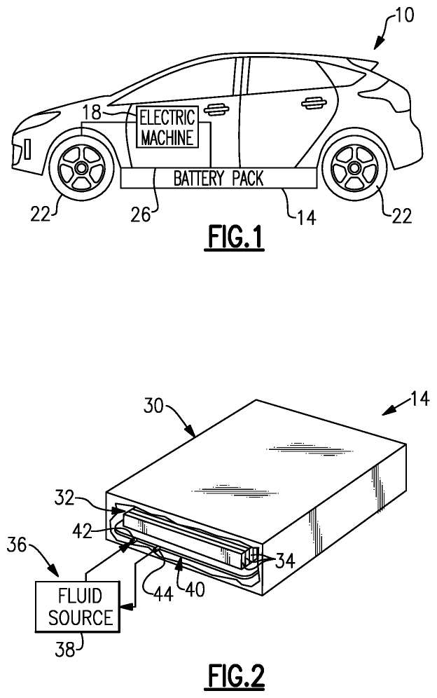

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

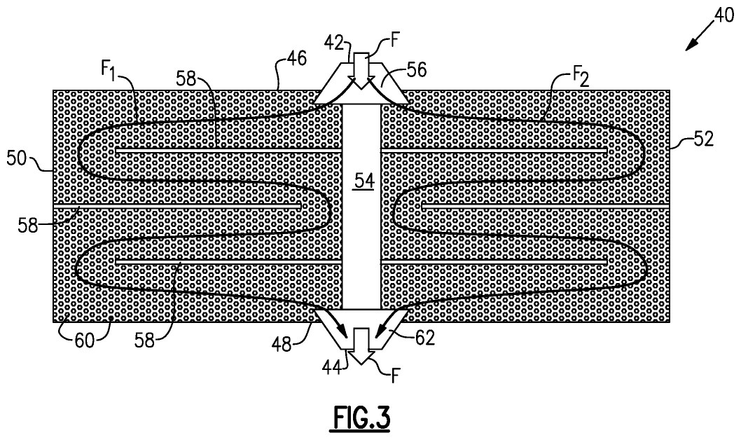

FIG. 2 illustrates additional detail of the battery pack 14. The battery pack 14 includes an enclosure assembly 30 including a plurality of walls, a tray, and/or a lid configured to enclose an interior of the battery pack 14 and separate the internal components of the battery pack 14 from the environment. One wall of the enclosure assembly 30 is partially removed for purposes of illustration only, such that some of the internal components of the battery pack 14 are visible.

In one non-limiting embodiment, the enclosure assembly 30 includes a tray and a cover which establish a plurality of walls that surround the interior of the battery pack 14. The enclosure assembly 30 may take any size, shape or configuration, and is not limited to the specific configuration of FIG. 2.

The battery pack 14 includes at least one battery array 32, which is a grouping of battery cells 34, for supplying electrical power to various vehicle components. Here, the battery pack 14 includes a single battery array. This disclosure extends to battery packs with a single battery array or multiple battery arrays. In other words, this disclosure is not limited to the specific configuration shown in FIG. 2.

The battery array 32 includes a plurality of battery cells 34 that may be stacked side-by-side along a length of each battery array 32. Although not shown in FIG. 2, the battery cells 34 are electrically connected to one another using busbar assemblies. In one embodiment, the battery cells 34 are prismatic, lithium-ion cells. However, battery cells having other geometries (cylindrical, pouch, etc.) and/or other chemistries (nickel-metal hydride, lead-acid, etc.) could alternatively be utilized within the scope of this disclosure.

During some conditions, heat may be generated by the battery cells 34, such as during charging and discharging operations. Heat may also be transferred into the battery cells 34 during vehicle key-off conditions as a result of relatively hot ambient conditions. During other conditions, such as relatively cold ambient conditions, the battery cells 34 may need to be heated. A thermal management system 36 may therefore be utilized to thermally condition (i.e., heat or cool) the battery cells 34.

The thermal management system 36, for example, may include a fluid source 38 and thermal exchange plate 40. The thermal exchange plate 40 may, in some examples, be referred to as a cold plate assembly. In one embodiment, an inlet 42 and an outlet 44 of the thermal exchange plate 40 fluidly couple the fluid source 38 to the thermal exchange plate 40. The locations of the inlet and outlet 42, 44 in FIG. 2 are not intended to be limiting and are only shown to schematically represent the inlet and outlet of the thermal exchange plate 40. More detail as to the locations of the inlet and outlet 42, 44 will be discussed below. The thermal management system 36 may include tubes, hoses, pipes, conduits, valves, pumps, or the like, to direct fluid to and from the fluid source 38 and the thermal exchange plate 40.

The fluid source 38 may include a source of fluid such as glycol or some other suitable fluid. The thermal management system 36 is operable to circulate the fluid through the thermal exchange plate 40, which is in contact, either directly or via a thermal interface material (TIM), with one or more surfaces of the battery cells 34, to either add or remove heat to/from the battery array 32. In one non-limiting embodiment, the battery array 32 is positioned atop the thermal exchange plate 40 so that the thermal exchange plate 40 is in contact, either directly or via a TIM, with a bottom surface of each battery cell 34.

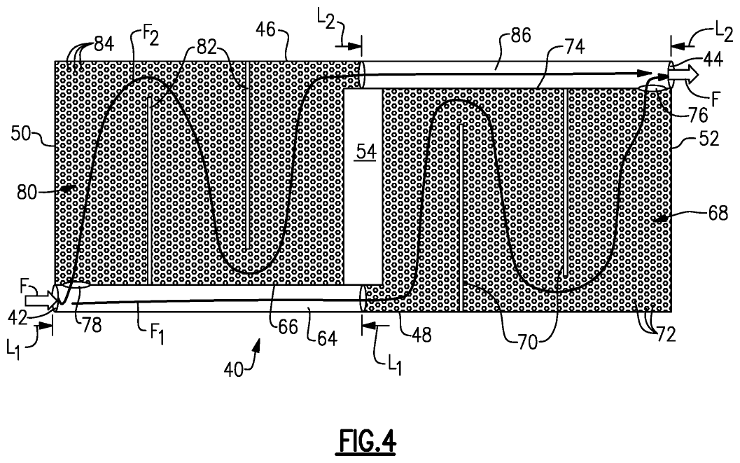

FIGS. 3 and 4 illustrate two embodiments of the thermal exchange plate 40 in more detail. In both embodiments, the thermal exchange plate 40 includes multiple flow paths of substantially equal length. In this way, all fluid flowing through the thermal exchange plate 40 travels a substantially equal distance through the thermal exchange plate 40, which provides for relatively low pressure loss, even fluid distribution, and relatively high heat transfer. While the thermal exchange plates shown in FIGS. 3 and 4 each include two flow paths, this disclosure extends to thermal exchange plates having two or more flow paths of substantially equal lengths.

As one would appreciate, FIGS. 3 and 4 illustrate the thermal exchange plate 40 from a top perspective with a top cover, or face sheet, of the thermal exchange plate 40 removed, such that the interior of the thermal exchange plate 40 is visible. The thermal exchange plate 40 is bound by a bottom cover, or face sheet, opposite the top cover. The height of the thermal exchange plate 40, which is a dimension extending in-and-out of the page in FIGS. 3 and 4, is substantially constant throughout the entire thermal exchange plate 40.

Further, when referencing a length of a flow path, this disclosure uses the term “length” to refer to the total distance that fluid travels along a particular path through the thermal exchange plate 40.

With respect to FIG. 3, the thermal exchange plate 40 includes a first side 46, a second side 48 generally opposite the first side 46, a first end 50 connecting the first and second sides 46, 48, and a second end 52 connecting the first and second sides 46, 48 opposite the first end 52. The sides 46, 48 and ends 50, 52 are walls extending in-and-out of the page between bottom and top covers of the thermal exchange plate 40.

In this example, the inlet 42 is formed in the first side 46 and the outlet 44 is formed in the second side 48. Specifically, the inlet 42 and outlet 44 are in a middle of the respective first and second sides 46, 48. A flow of fluid F from the fluid source 38 is first directed into the inlet 42. Downstream of the inlet 42, a separator 54 splits the fluid F such that some of the fluid flows along a first flow path F₁, and a remainder of the fluid flows along a second flow path F₂. The separator 54 exhibits a length dimension arranged along a center of the thermal exchange plate 40. The separator 54 is a wall extending from the bottom to the top cover of the thermal exchange plate 40 and fluidly isolates the first and second flow paths F₁, F₂. The first and second flow paths F₁, F₂ are of substantially equal length such that fluid flowing along the first and second flow paths F₁, F₂ will travel substantially the same distance between the inlet 42 and the outlet 44.

With reference to the first flow path F₁, substantially half the fluid F entering the inlet 42 is directed into the first flow path F₁ via an inlet plenum 56, which is formed between the inlet 42 and the separator 54. The first flow path F₁ is bound by the separator 54, the sides 46, 48, and the end 50 (and, as one would understand, the top and bottom cover of the thermal exchange plate 40). The first flow path F₁ includes a plurality of thermal exchange features, including three baffles 58 configured to establish a serpentine flow path. While three baffles 58 are shown, this disclosure is not limited to a particular quantity of baffles. The first flow path F₁ also includes additional thermal exchange features, which here includes a plurality of turbulators 60 configured to induce turbulence and/or increase the effective surface area of the thermal exchange plate 40 in contact with the fluid flowing along the first flow path F₁, which provides for efficient and effective heat transfer. Example turbulators include fins, trip strips, indents in a top cover and/or bottom cover of the thermal exchange plate 40, etc.

Upstream of the outlet 44, fluid flowing along the first flow path F₁ enters an outlet plenum 62 between separator 54 and outlet 44. The inlet and outlet plenums 56, 62 are free of any thermal exchange features. Within the outlet plenum 62, fluid that has flowed along the first flow path F₁ merges with fluid that has flowed along the second flow path F₂, and the combined flow exits the thermal exchange plate 40 via the outlet 44, where the flow of fluid F is directed back to the fluid source 38 or to another downstream location.

While the first flow path F₁ has been described in detail, the second flow path F₂ is configured in substantially the same manner. The second flow path F₂ is a mirror image of the first flow path F₁, reflected about the center of the thermal exchange plate 40. The thermal exchange plate 40, and in particular the separator 54, prevents fluid flowing along the first and second flow paths F₁, F₂ from intermixing, with the exception of when the fluid is in the inlet and outlet plenums 56, 62.

The first and second flow paths F₁, F₂ are of a substantially equal length. The first and second flow paths F₁, F₂ are designed to be of an equal length, in one particular example. The term “substantially equal” is intended to account for normal manufacturing tolerances and variability in fluid flow.

FIG. 4 illustrates another example of the thermal exchange plate 40. In this example, the inlet 42 is arranged in the end 50, adjacent a corner of the end 50 and the side 48. The outlet 44 is arranged in the end 52, adjacent a corner of the end 52 and the side 46.

With reference to the first flow path F₁, the first flow path F₁ includes a first section 64 which is free of (i.e., does not include) thermal exchange features. In an example, the walls defining a boundary of the first section 64 are substantially smooth and free of raised surfaces or projections, such as baffles, fins, trip strips, etc. The first section 64 is a relatively narrow channel extending from the inlet 42 to a location along a center of the thermal exchange plate 40 adjacent the separator 54. The first section 64 is bound by the side 48 and a separator wall 66 extending between end 50 and separator 54. The first section 64 exhibits a length L₁.

Downstream of the first section 64, the first flow path F₁ includes a second section 68, which does include thermal exchange features, including two baffles 70 and a plurality of turbulators 72, in this example. The second section 68 is bound by the separator 54, side 48, end 52, and a separator wall 74, which extends between end 52 and separator 54. As in the embodiment of FIG. 3, the baffles 70 establish a serpentine flow path along the second section 68, and the turbulators 72 induce turbulence and/or increase the effective surface area in contact with fluid to increase heat transfer.

Fluid exits the first flow path F₁ by flowing through an opening 76 formed in separator wall 74. The opening 76 is adjacent, and upstream of, outlet 44. At this location, the fluid that flowed along the first flow path F₁ merges with fluid that flowed along the second flow path F₂ and exits the thermal exchange plate 40 via the outlet 44.

Fluid flowing along the second flow path F₂ enters the second flow path F₂ via an opening 78 formed in the separator wall 66. The opening 78 naturally creates a split, such that substantially half the fluid entering the inlet 42 enters the opening 78 and travels along the second flow path F₂, while substantially the other half travels along the first flow path F₁. The opening 78 is adjacent, and downstream of, inlet 42. Downstream of the opening 78, the second flow path F₂ includes a first section 80 bound by side 46, end 50, separator 54 and separator wall 66. The first section 80 includes thermal exchange features, namely baffles 82 and turbulators 84.

Downstream of the first section 80, the second flow path F₂ includes a second section 86 which is free of thermal exchange features. In an example, the walls defining a boundary of the second section 86 are substantially smooth and free of raised surfaces or projections. The second section 86 is a relatively narrow channel extending from a center of the thermal exchange plate 40 to the outlet 44. The second section 86 is bound by the side 46 and separator wall 74. The second section 86 exhibits a length L₂ which is substantially equal to the length L₁. Further, the length of the second section 68 of the first flow path F₁ is substantially equal to the length of the first section 80 of the second flow path F₂. As such, the first and second flow paths F₁, F₂ are of substantially equal length, which achieves relatively low pressure loss while providing an even distribution of fluid within the thermal exchange plate 40, leading to relatively high heat transfer.

It should be understood that terms such as “about,” “substantially,” and “generally” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery assembly, comprising:
a plurality of battery cells; and
a thermal exchange plate configured to thermally condition the plurality of battery cells, wherein the thermal exchange plate includes a first flow path and a second flow path, wherein the first flow path has a length substantially equal to a length of the second flow path.

2. The battery assembly as recited in claim 1, wherein:
the thermal exchange plate includes an inlet and an outlet,
the thermal exchange plate is configured such that fluid entering the inlet is split and flows through either the first flow path and the second flow path, and
both the first flow path and the second flow path direct fluid to the outlet.

3. The battery assembly as recited in claim 2, wherein the first flow path and the second flow path merge at a location upstream of the outlet.

4. The battery assembly as recited in claim 2, wherein:
downstream of the inlet, the first flow path includes a first section free of thermal exchange features, and
downstream of the first section of the first flow path, the first flow path includes a second section including thermal exchange features.

5. The battery assembly as recited in claim 4, wherein:
downstream of the inlet, the second flow path includes a first section including thermal exchange features, and
downstream of the first section of the second flow path, the second flow path includes a second section free of thermal exchange features.

6. The battery assembly as recited in claim 5, wherein a length of the first section of the first flow path is substantially equal to a length of the second section of the second flow path.

7. The battery assembly as recited in claim 6, wherein a length of the second section of the first flow path is substantially equal to a length of the first section of the second flow path.

8. The battery assembly as recited in claim 5, wherein the thermal exchange features of the second section of the first flow path and the first section of the second flow path include baffles.

9. The battery assembly as recited in claim 8, wherein the baffles are arranged to establish a serpentine flow path within the second section of the first flow path and the first section of the second flow path.

10. The battery assembly as recited in claim 5, wherein the thermal exchange features of the second section of the first flow path and the first section of the second flow path include turbulators.

11. The battery assembly as recited in claim 5, wherein the thermal exchange features of the second section of the first flow path and the first section of the second flow path include fins.

12. The battery assembly as recited in claim 1, wherein the thermal exchange plate is in contact with the plurality of battery cells either directly or by way of a thermally interface material.

13. The battery assembly as recited in claim 1, further comprising a source of fluid in communication with the thermal exchange plate.

14. The battery assembly as recited in claim 1, wherein the battery assembly is a battery assembly of an electrified vehicle.

15. A method of an assembly, comprising:
establishing a flow of fluid within a thermal exchange plate of a battery assembly such that the fluid flows along either a first flow path or a second flow path, wherein the first flow path has a length substantially equal to a length of the second flow path.

16. The method as recited in claim 15, wherein:
the thermal exchange plate includes an inlet and an outlet,
downstream of the inlet, fluid splits and flows through either the first flow path and the second flow path, and
both the first flow path and the second flow path direct fluid to the outlet.

17. The method as recited in claim 16, wherein the first flow path and the second flow path merge at a location upstream of the outlet.

18. The method as recited in claim 16, wherein:
downstream of the inlet, the first flow path includes a first section free of thermal exchange features,
downstream of the first section of the first flow path, the first flow path includes a second section including thermal exchange features,
downstream of the inlet, the second flow path includes a first section including thermal exchange features, and
downstream of the first section of the second flow path, the second flow path includes a second section free of thermal exchange features.

19. The method as recited in claim 18, wherein a length of the first section of the first flow path is substantially equal to a length of the second section of the second flow path.

20. The method as recited in claim 19, wherein a length of the second section of the first flow path is substantially equal to a length of the first section of the second flow path.
